(19) United States
(12) Patent Application Publication
(10) Pub. No.: US 2011/0258112 A1
(43) Pub. Date: Oct. 20, 2011

(54) SYSTEM AND METHOD FOR CHARGING A VEHICLE

(75) Inventors: John Eder, Floral Park, NY (US); Scot J. Hale, Williston Park, NY (US); James A. Porter, Farmingdale, NY (US)

(73) Assignee: Leviton Manufacturing Company Inc., Melville, NY (US)

(21) Appl. No.: 13/126,886

(22) PCT Filed: Oct. 30, 2009
(86) PCT No.: PCT/US09/62825

§ 371 Date: Jul. 11, 2011

Related U.S. Application Data
(60) Provisional application No. 61/110,099, filed on Oct. 31, 2008.

(51) Int. Cl. G06Q 40/00; H02J 7/00

(52) U.S. Cl. 705/39; 320/109

(57) ABSTRACT

A system and method for charging a vehicle, including receiving electricity via a wall box mounted electrical receptacle or a plug-in receptacle electrically connected to an electrical energy source; establishing a connection between a communication module of the wall box mounted electrical receptacle or the plug-in receptacle and a communications network; receiving electrical energy source data; and controlling the charging of an electrical storage device of the vehicle by automatically controlling the charging based on the electrical energy source data.

### CROSS REFERENCE TO RELATED APPLICATIONS

The present application claims priority to United States Provisional Application Ser. No. 61/110,099, filed Oct. 31, 2008, entitled “SYSTEM AND METHOD OF CHARGING AN ELECTRIC VEHICLE,” the contents of which are hereby incorporated by reference in their entirety.

### BACKGROUND

1. Field of the Related Art

The present disclosure relates to vehicles, and more particularly, to a method and system for enabling an electrical storage device of a vehicle to be charged and recharged.

2. Description of the Related Art

Modern vehicles generally utilize combustion engines for mechanical power to propel the vehicle, e.g., cars, trucks, trains, motorcycles, boats, and the like typically employ combustion engines.

One type of technology employed to increase gas mileage of automobiles utilizes electric motors, combustion engines, regenerative braking, and electric batteries. These hybrid cars typically propel the vehicle via an electric motor that is connected to a battery (e.g., a lithium-ion batter) source and/or an electric generator connected to a combustion engine. A control system controls the balance of power used from the battery and from the generator driven by the combustion engine. Other hybrid cars may be driven by a special engine that includes both a combustion engine mechanically coupled to a drive train and an electric motor mechanically coupled to the same drive train. The electric motor and/or combustion engine both provide mechanical power to the drive train. However, a control system determines optimal operating parameters of both power sources simultaneously. Purely electric cars are also available for efficiency. These vehicles include an electric motor powered by batteries. The car is periodically plugged into an electric grid to receive electric power.

As a result, the electric car, electric vehicle (EV) and battery electric vehicle are all used to describe automobiles powered by one or more electric motors utilizing energy stored in rechargeable batteries. The batteries are recharged by connecting to an electrical outlet. Efficient recharging of the batteries typically requires hours and is often done overnight or while the vehicle is parked for a significant time. Thus, the use of electric vehicles is affected by the sparse availability of efficient recharging facilities and efficient recharging tools.

### SUMMARY

Objects and advantages of the present disclosure will be set forth in the following description, or may be obvious from the description, or may be learned through practice of the present disclosure.

The present disclosure provides a method for charging a vehicle, the vehicle being at least partially powered by electricity, including: receiving electricity via a wall box mounted electrical receptacle or a plug-in receptacle electrically connected to an electrical energy source; establishing a connection between a communication module of the wall box mounted electrical receptacle or the plug-in receptacle and a communications network; receiving electrical energy source data; and controlling the charging of an electrical storage device of the vehicle by automatically controlling the charging based on the electrical energy source data.

The present disclosure further provides a charger for an electrical storage device of a vehicle at least partially powered by electricity, including: a wall box mounted electrical receptacle or a plug-in receptacle configured to receive electricity from an electric power source; a processing module for controlling the charger by automatically activating charging during at least one predetermined period; a charge regulator for implementing one or more charging algorithms; an electricity rate calculation module for monitoring at least one charging parameter; and a data collection module for storing usage data; and a communications module configured to communicate over a communications network.

The present disclosure further provides a method for charging an electrical storage device of a vehicle, including: connecting a vehicle to a wall box mounted electrical receptacle or a plug-in receptacle charger; wherein the wall box mounted electrical receptacle or plug-in receptacle charger performs the steps of: receiving electricity data from a source or stored data; calculating a predetermined period in accordance with the electricity data; transacting a payment mechanism; and providing electricity to the electrical storage device of the vehicle.

Additional objects and advantages of the present disclosure are set forth in, or will be apparent to those skilled in the art from, the detailed description herein. Also, it should be further appreciated that modifications and variations to the specifically illustrated, referenced, and discussed steps, or features hereof may be practiced in various uses and embodiments of the present disclosure without departing from the spirit and scope thereof, by virtue of the present reference thereto. Such variations may include, but are not limited to, substitution of equivalent steps, referenced or discussed, and the functional, operational, or positional reversal of various features, steps, parts, or the like. Still further, it is to be understood that different embodiments, as well as different presently preferred embodiments, of the present disclosure may include various combinations or configurations of presently disclosed features or elements, or their equivalents (including combinations of features or parts or configurations thereof not expressly shown in the figures or stated in the detailed description).

### BRIEF DESCRIPTION OF THE DRAWINGS

The foregoing and other objects, features, and advantages of the present disclosure will be apparent from the following more particular description of preferred embodiments as illustrated in the accompanying drawings, in which reference characters refer to the same parts throughout the various views. The drawings are not necessarily to scale, emphasis instead being placed upon illustrating principles of the present disclosure.

FIG. 1 is a schematic diagram of an electrical storage device of a vehicle in communication with an electrical storage device charger, in accordance with the present disclosure; and

FIG. 2 is a flowchart illustrating a method of charging an electrical storage device of a vehicle, in accordance with the present disclosure.

While the above-identified drawing figures set forth alternative embodiments, other embodiments of the present disclosure are also contemplated, as noted in the discussion. In all cases, this disclosure presents illustrated embodiments by way of representation and not limitation. Numerous other modifications and embodiments may be devised by those skilled in the art which fall within the scope and spirit of the principles of the present disclosure.

### DETAILED DESCRIPTION

There is a need in the art for an interface for a vehicle, such as an electric vehicle (EV) or plug-in hybrid electric vehicle (PHEV), wherein the vehicle operates at least partially on electricity, battery power, an electrical storage device, or the like. In addition, the vehicle may optionally include an internal combustion engine in combination with an electrical storage device to form a hybrid system. Therefore, an interface system for a complete plug in electric vehicle that relies at least partially, or wholly, on battery power to propel the vehicle is needed. There also is a need in the art for a communication interface for an electric vehicle or PHEV that is able to control remotely the charging of the electrical storage device and the discharging of the electrical storage device to an electric grid during predetermined periods of time (e.g., low consumption of power periods). There also is a need in the art for a communication interface for an electric vehicle or PHEV that notifies the user of any potential issues during the charging of the vehicle and potential problems throughout the vehicle environment that may hinder the performance of the electrical storage device and hence, the ability of the vehicle to travel a predetermined distance of miles. For the purposes of simplicity, when referring to “electric vehicle” below, it is intended that this term includes any vehicle which operates or is propelled at least partially by electricity. Similarly, an electric vehicle may be powered by any suitable electrical storage device, an electrical source, a battery, fuel cell, solar cell, thermal energy device or the like. As such, while the description below may refer to a battery for simplicity, it should be understood that this disclosure contemplates any other suitable electrical storage device.

The present disclosure proposes providing a vehicle interface that is capable of interfacing from the user to the vehicle regarding the electric storage device and charging thereof. The present disclosure further proposes a vehicle receiving the electricity via a wall box mounted electrical receptacle or a plug-in receptacle. A connection can then be established between a communication module of the wall box mounted electrical receptacle or the plug-in receptacle and an energy source connected to an electricity grid network.

The present disclosure further proposes providing a vehicle communication interface where the user may be notified by the vehicle of any suitable condition such as issues with the electrical storage device during charging or when the electrical storage device is fully charged and ready for use.

The present disclosure further proposes providing a vehicle communication interface that allows the user to pre-register with local or remote utility companies (e.g., power station, home charging station, service station, municipal station, or an institutional station) and an energy provider (or any other suitable entity) to control the timing of charging of the vehicle, such that charging occurs during a predetermined time, such as low power consumption times at a lower cost to the vehicle user. Additionally, the vehicle may receive the electricity directly via a wall box mounted electrical receptacle or a plug-in receptacle. A connection can then be established between a communication module of the wall box mounted electrical receptacle or the plug-in receptacle and an energy source connected to an electricity grid network. Thus, the communication module may be incorporated or operatively associated with (i) the vehicle or with (ii) the wall box mounted electrical receptacle or a plug-in receptacle.

The present disclosure further proposes providing a vehicle communication interface capable of transferring predetermined data/information to or from a vehicle via a link or network to a manufacturer's server or to a user's computer to create a database of user data to ensure proper operation of the vehicle and associated batteries. In addition, the vehicle communication interface may be capable of transferring data/information to any suitable device or network (such as the internet) by any suitable method.

For the purposes of this disclosure, a computer readable medium stores computer data in machine readable form. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which may be used to store the desired information and which may be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module may include sub-modules. Software components of a module may be stored on a computer readable medium. Modules may be integral to one or more servers, or be loaded and executed by one or more servers. One or more modules may be grouped into an engine or an application.

“Power grid” as used herein means a power distribution system/network/infrastructure that connects producers of power with consumers of power. The network may include generators, transformers, interconnects, switching stations, and safety equipment as part of either/both the transmission system (i.e., bulk power) or the distribution system (i.e., retail power).

“Grid conditions” as used herein, means the need for more or less power flowing in or out of a section of the electric power grid, in a response to one of a number of conditions, for example supply changes, demand changes, contingencies and failures, ramping events, etc. These grid conditions typically manifest themselves as power quality events such as under- or over-voltage events and under- or over-frequency events. In addition, “grid conditions” may refer to any suitable conditions affecting the electric power grid.

Embodiments will be described below while referencing the accompanying figures. The accompanying figures are merely examples and are not intended to limit the scope of the present disclosure.

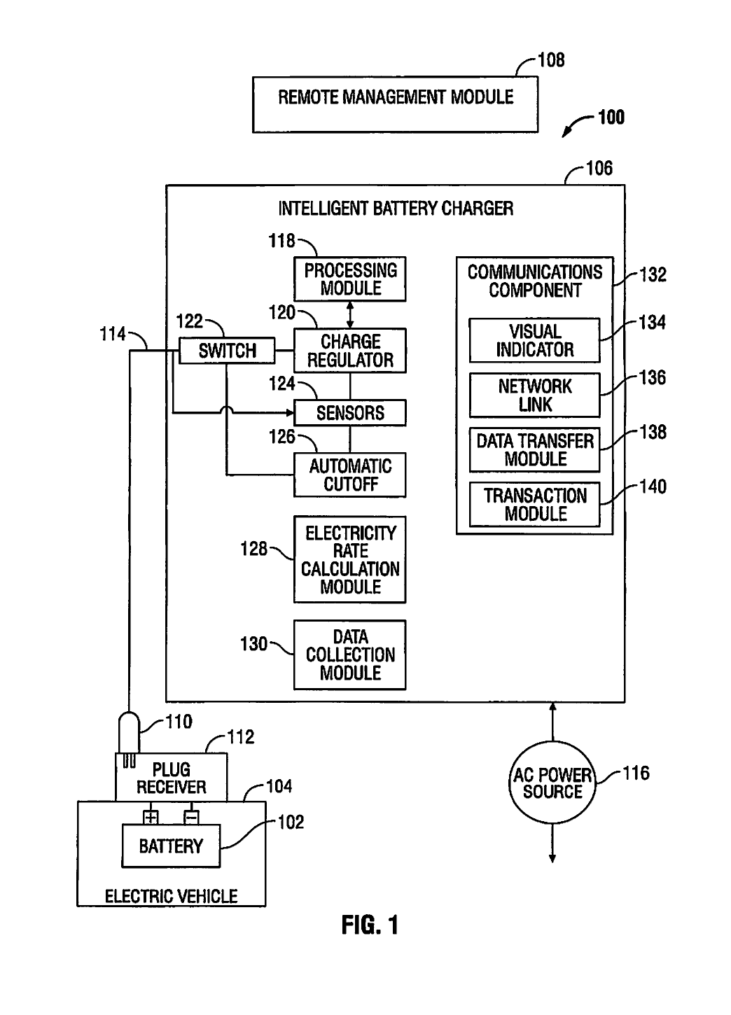

Referring to the drawings, FIG. 1 shows a system 100 for charging a battery 102 of a vehicle 104 in accordance with the present disclosure. Vehicle 104 may be an electric car, a hybrid car that relies on both fossil-fuel and electric power sources, a vehicle that relies on electric power and the like. Vehicle 104 may be in the form of any vehicle where the at least a part of the propulsion of the vehicle relies on electrical energy. Vehicle 104 may be in communication with a vehicle communication interface.

The vehicle communication interface described herein may be used in any type of vehicle including an automobile, boat, train, plane, or any other transportation vehicle. The vehicle 104 may operate completely on battery power for all propulsion and other related needs (i.e., automotive needs). The vehicle 104 may use a battery pack made of any suitable materials such as sheets of cells of lithium ion batteries arranged in a predetermined pattern. This battery pack allows for propulsion of the vehicle 104 some distance before recharge is necessary. It should also be noted that the vehicle 104 may be used in any other type of suitable vehicle, such as internal combustion, hydrogen cell vehicle, hybrid vehicle, alternate fuel type vehicle, or any other type of compulsion system for a vehicle.

Additionally, system 100 includes an intelligent battery charger 106 and a remote management module 108. Remote management module 108 may be partly located in proximity to intelligent battery charger 106 and/or may be in operative communication therewith, e.g., intelligent battery charger 106 may be networked with remote management module 108 via TCP/IP, the internet, via infrared link, via IrDA or any other suitable wired or wireless communications technology. Additionally or alternatively, remote management module 108 may be integrated at least partially within vehicle 104, e.g., such as a plug-in module, within the dashboard of vehicle 104, as part of a charging station (not shown), and/or the like. The communications components 132 allows for communication with a network that may be cellular, internet, satellite or any other type of network or with a wired or wireless access point.

Remote management module 108 may control start and stop settings on the delivery of power, may provide instructions to record wattage and time, and may receive reports concerning service interruptions due to electrical storage device failure or disconnect. The remote management module 108 may also be involved in transacting the purchase of electricity. Remote management module 108 may be used in any suitable manner in order to receive/transmit any suitable information or data.

System 100 may charge battery 102 of vehicle 104. System 100 includes a plug 110 that is received by plug receiver 112 of vehicle 104. Alternately system 100 may implement any suitable device or method instead of plug 110 and plug receiver 112. Intelligent battery charger 106 may control the charging of battery 102 by supplying electric current with sufficient power, current, and voltage via a wire 114. The electric current may be received via a wall mounted electrical receptacle or a plug-in receptacle electrically connected to an electrical energy source. A communication module may be located within the wall box mounted electrical receptacle or the plug-in receptacle for establishing a connection to a communications network. The communication module may be one of a powerline carrier, a serial port, a parallel port, IEEE 802.11, Z-wave, ZigBee, Bluetooth, Ethernet or the like or any combination thereof. One skilled in the art may contemplate a variety of different communication module types and configurations.

Although the present embodiment charges the battery via a wire 114, other charging mediums may be implemented in other embodiments such as wireless energy transfer, inductive charging, microwave or radio power transmission, laser power transmission, electro-dynamic induction, or the like. Intelligent battery charger 106 receives energy from AC power source 116, which may be part of an industrial power grid, a residential power grid, an electric generator, and the like. However, in other embodiments intelligent battery charger 106 may be powered by a DC power source, e.g., directly from solar cells.

Additionally, the AC power source 116 may be replaced with any type of power supply. The power supply may include multiple alternating current and direct current inputs and outputs, or a combination thereof. One of the inputs may be a back-up energy source which is carried on board within the power supply. The back-up energy source may be batteries or fuel cells. An enclosure may be used to house the power supply and be expandable to include additional battery racks each housed within an individual frame of the enclosure. The power supply may also be expanded by interconnecting separate enclosures with the use of appropriate cables. The power supply may be microprocessor controlled (e.g., processing module 118) based on the status (e.g., voltage, current and temperature) of the inputs including the status of the back-up energy source, the status of converters and internal buses, and the status of the outputs (or any other suitable status or condition). The processing module 118 may manage the back-up energy source and the overall operation of the power supply by selectively coupling system inputs, buses and outputs. The processing module 118 may be a microprocessor, a computer, and a server. The power supply may be directly controlled by the user or by a utility company and function only when the utility rates are at their lowest rate during the day, or week, or month, etc. The power supply may be activated periodically in accordance with a plurality of parameters or variables.

Intelligent battery charger 106 includes a processing module 118, a charge regulator 120, switch 122, sensors, 124, automatic cutoff 126, electricity rate calculation module 128, data collection module 130 and a communications component 132. Communications component 132 includes an indicator 134, a network link 136, a data transfer module 138, and a transaction module 140. Indicator 134 may be visual, audible, or a combination thereof or be any other suitable indicator.

Intelligent battery charger 106 may be controlled by processing module 118. Processing module 118 may include a processor, memory and hardware interface circuitry. Processing module 118 may communicate with any part of intelligent battery charger 106, although, for simplicity, not all electrical couplings or communication links are shown. Processing module 118 communicates with charge regulator 120 to control the charging of battery 102. Processing module 118 may also determine parameters related to the particular type of battery or model of battery connected via wire 114.

Charge regulator 120 implements a constant-voltage, constant-current charging algorithm, or other charging algorithm. Sensor 124 may include current sensors, power sensors, voltage sensors, connection state sensors, arc sensors, surge sensors, temperature sensors, or other suitable related sensors. Sensors 124 may be utilized by charge regulator 120, processing module 118, and/or automatic cutoff 126. Charge regulator 120 may be a battery power generator, a solar power generator, or a wind power generator.

Switch 122 may electrically connect or disconnect wire 114 from charge regulator 120 and may be controlled by automatic cutoff 126. Automatic cutoff 126 may provide an additional safety circuit which disconnects wire 114 in certain irregular conditions, e.g., unusually high current, voltage, power, an unusually long charge time, or other detected undesirable condition. Automatic cutoff 126 may have an independent power source, such as a backup battery or any type of electrical storage device (e.g., fuel cell, solar cell, thermal energy device or the like).

Additionally or alternatively, automatic cutoff may be “normally off”, e.g., if intelligent battery charger 106 does not receive power from AC power source 116 (or as a backup directly from battery 102) then intelligent battery may automatically disconnect. For example, switch 122 may be a normally open relay thereby requiring automatic cutoff 126 to constantly supply power thereto while charging battery 102. Automatic cutoff 126 and/or switch 122 may include GFCI, arc fault protection, equipment leakage, overcurrent, overvoltage, or any other suitable type of circuit protection.

Electricity rate calculation module 128 determines optimal charging time, day, or other optimal charging parameters. The electricity rate calculation module 128 may be a wattmeter, ammeter, voltmeter, and electricity meter. For example, processing module 118 may utilize data received from electricity rate calculation module 128 to charge battery 102 of vehicle 104 during times of the day in which electricity rates are lower, which in turn lowers electric grid peak usage. Electricity rate calculation module 128 may download data relating to electricity rates via communication component 132, may have the data store, may have an input interface to receive that data, or otherwise acquires and/or maintains data relating to electricity rates.

Data collection module 130 stores usage data, e.g., watts used as a function of time, voltage, current, power, noise, Q-factor, Harmonics, or other electrically related data values. A harmonic may be a signal or wave whose frequency is an integral (whole-number) multiple of the frequency of some reference signal or wave. The term “Harmonic” can also refer to the ratio of the frequency of such a signal or wave to the frequency of the reference signal or wave. These are signals transmitted and received by the vehicle 104. The term “Q-factor” or quality factor is a dimensionless parameter that describes how under-damped an oscillator or resonator is or equivalently, characterizes a resonator's bandwidth relative to its center frequency. The data collection module 130 may collect and store a plurality of different data, such as electrical energy source data. The electrical energy source data may include, but is not limited, to the following: time of day rates, load demand on the energy source network, etc. The load demand on the energy source network may include a utility broadcasting a high power usage signal that should instruct the charger 106 to not charge or to limit the charging rate, etc. It is contemplated that the data may be any type of data/information, such as, but not limited to, rate data, load data, demand data, and/or quality data.

Data collection module 130 may be extracted by a user via USB, a RJ45 connection, other direct electrical connection or via communication component 132, or any other suitable wired or wireless communication link. Data collection module 130 may be a flash memory, hard drive, ROM, volatile RAM, non-volatile RAM, CD-ROM, DVD-ROM, magnetic disk, or optical disk. Alternatively, the user may set the system to charge the vehicle during any suitable time period such as that based on typical usage, demand, or any other suitable time period in addition to the electrical rate.

Electricity grids have periods of high demand from customers where the demand may approach or even exceed the electricity supply. Conversely, there are periods of low demand which coincide with high electricity production. Demand response is a mechanism for reducing consumption of electricity during periods of high demand. For example, consumer services such as air conditioning and lighting may be reduced during periods of high demand according to a preplanned load prioritization scheme. Demand response may also be used to increase demand at times of high electricity production. For example, the cost of electricity may be reduced during periods of low demand. Furthermore, some demand response systems encourage energy storage during periods of low demand, for release back into the electricity grid during periods of high demand. For example, battery run vehicles may be charged during periods of low power demand and then release power back to the grid during periods of high demand. It is envisioned that the system 100 is utilized during low power demand grid periods.

Vehicles 104 may be recharged from a local electricity grid. These vehicles 104 may also be a source of electric power to be transferred to the local electricity grid. The transfer of electricity stored in vehicles 104 to the local electric grid is referred to as vehicle-to-grid (V2G). V2G is particularly attractive for vehicles 104 which have their own charging devices, such as battery run vehicles with regenerative braking and plug-in hybrid vehicles. V2G is desirable for peak load leveling (e.g., helping to meet the demand for electricity when demand is at its highest. For demand response and V2G to be implemented effectively, real time communication of a need for power input into the local electricity grid is required. This communication from electric utility companies needs to reach recharging facility managers and vehicle owners and users.

The method of transferring charge between a local power grid and an vehicle 104 may also include the step of determining charge transfer parameters. This determination may be based on any suitable parameter such as power grid load data, provided by the utility company and available on a server or a network. For example, the utility company's demand response system may limit recharging of vehicles 104 during periods of high electricity demand. This determination may also be made based on the user profile provided by the vehicle operator and available on the server and/or network. Also, the user profile may include information such as whether the vehicle operator wants to: charge the vehicle 104 only during periods of lower power rates, not charge the vehicle 104 during periods of high power grid load, and sell power to the local grid.

Furthermore, the user may be capable of discharging the battery 102 into the electricity or electric grid of the locale in which the vehicle 104 is either charged or stored via a vehicle to grid application or system that allows for communication between a local utility company server and the vehicle 104, thus allowing for certain operations to be performed by the utility company and the user on the vehicle 104. Yet another use would be to alert the user or manufacturer that the battery 102 is falling below the minimum accepted storage levels (3.0V for example). Such discharge of the battery 102 may allow the user to plug in the vehicle 104 or recharge the battery 102 by other means to preserve the battery 102.

Communications component 132 includes an indicator 134 (e.g., visual, audible, combination thereof, or otherwise), a network link 136, a data transfer module 138 and a transaction module 140. For example, the indicator 134 may be a LED bar or other visual indicator indicating percent charge, percent complete, charging status, charging state, plug 110 connected/disconnected indication, data full indication, cost of power being consumed on a total charge basis or time basis, or other related indication.

The visual indicator 134 may include an in vehicle display which may be any known display such as a touch screen, screen, TV, LCD, plasma, CRT tube or any other type of display device known. The dashboard display may be arranged in any part of the vehicle 104 including but not limited to sun visors, heads up displays, anywhere in the instrument panel, anywhere in the seats, or any other position within the vehicle 104 and it is even contemplated to have a touch screen on the outer surface of the vehicle 104. When the user or driver of the vehicle 104 turns off the motor of the vehicle 104, the user may be prompted via the display device in the vehicle 104 to choose or select one of a plurality of predetermined charging options for the vehicle battery pack. It should be noted that the user may also use a menu or voice controlled device that allows for selection of a next charge state at any time during use of the vehicle 104. Thus, the visual indicator 134 may be LEDs that are capable of showing a number of different colors and may be capable of continuous or flashing modes of operation. Alternatively, the visual indicator 134 may be replaced by an alphanumeric display.

It should also be noted that the charging options may also include within its methodology a follow up menu that allows the user or driver of the vehicle 104 the choice of setting one of the predetermined charging options as the default such that every time the user exits the vehicle 104 and begins charging of the battery pack within the vehicle 104 such setting are automatically used for charging thereof.

Network link 136 may facilitate remote management module 108 to communicate and/or control intelligent battery charger 106. Data transfer module 138 facilitates the transfer of data collection module 130 to a user, e.g., through a USB connection, through network link 136, or otherwise. Transaction module 140 may facilitate a purchase of electricity and may accomplish this via use of an associated credit card, an RFID communications link, or other electronic transaction mechanism.

Thus, communications networks are a part of the vehicle recharging process. The data transfer module 138 may operate in accordance with a variety of different technologies. For example, radio frequency identification (RFID) technology may be used. A radio frequency identification transmitter, receiver, or transceiver, commonly referred to as an RFID transmitter, is used for short range communication with a counterpart RFID transmitter, receiver, or transceiver. Typical ranges are of the order of one meter to tens of meters. An example of an RFID transmitter is a remote keyless entry device.

The RFID transceiver may be used for short range communication with an RFID transponder. Typical ranges are of the order of one meter for communication with passive transponders and hundreds of meters for communication with active transponders. The longer range of the active transponders is due to a power supply integrated into the transponder. RFID transponders store information which is broadcast over radio frequencies when prompted by a specific radio frequency signal from an RFID transceiver. An example of an RFID transponder is a FasTrak® card provided by the State of California, primarily used for payment of automotive tolls in the west coast or E-Z Pass® used in the east coast and provided by E-Z Pass Interagency Group™ (IAG). Each FasTrak® or E-Z Pass® card/module has a unique code which is associated with a debit account. Each time a FasTrak® or E-Z Pass® card/module passes through a toll collection point, the unique code is transmitted by the card in response to being interrogated by an RFID transceiver. The code is detected by the RFID transceiver and the toll is debited from the user's account. Similarly, such technologies may be incorporated into the system 100 in order to monitor, manage, manipulate, update, and/or record vehicle 104 data or information in a continuous manner and in a real-time basis.

Additionally, a payment means, such as a payment station (not shown) may be provided. The payment station may be several tens of meters remote from the vehicle 104. The payment station may include a currency reader, a credit card reader, a receipt printer, a display and input buttons. However, the payment station does not have to include all of these components and may include alternate or additional components. For example, some payment stations may not include a currency reader and may only allow payment by credit card using the credit card reader. The user of the vehicle 104 may use the payment station to pay for and schedule recharging of the vehicle 104, and also for V2G transactions. The payment mechanism may be an electronic payment, a cash payment, a check payment, a token payment, electromechanical payment, wireless payment, wired payment or any combination thereof.

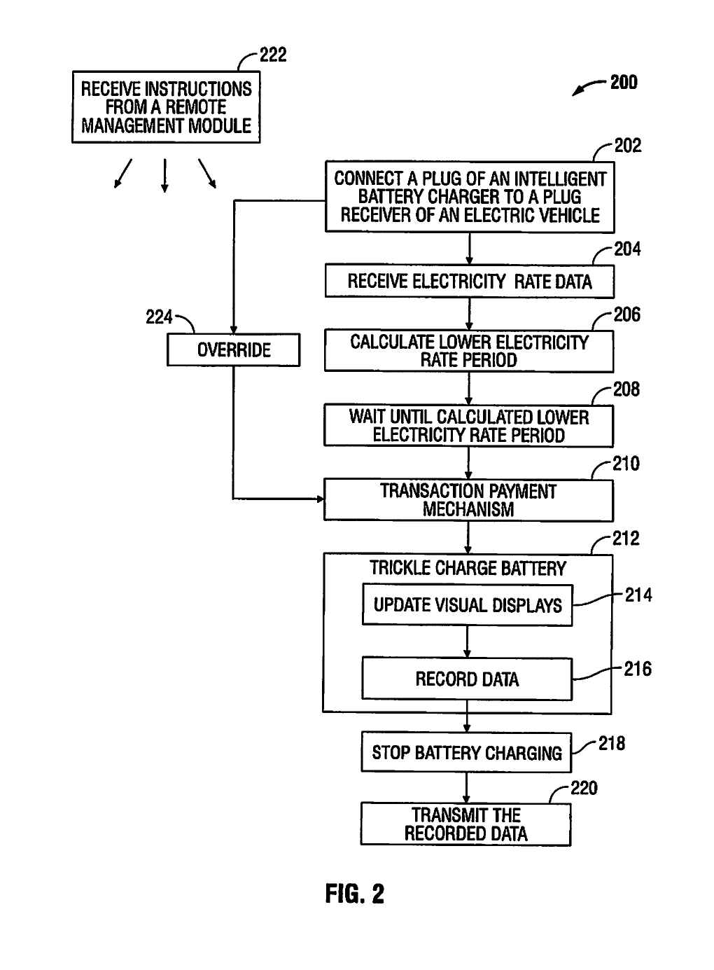

Referring to the drawings, FIG. 2 is a method 200 of charging a vehicle battery in accordance with the present disclosure. Method 200 includes steps 202 through 224. Step 202 connects a plug of an intelligent battery charger to a plug receiver of a vehicle (although the connection may be made in any suitable manner). Step 204 receives electricity rate data. Step 206 calculates a lower electricity rate period, e.g., calculates the most inexpensive time range to charge the vehicle if configured to minimize charging costs or based upon other parameters. Step 206 may alternately calculate any suitable alternate charging period based on any other parameters such as user preferences, etc.

Step 208 waits until calculated lower electric rate period begins. Step 210 transacts payment mechanism, e.g., charges an account or credit card. Step 210 may use RFID based transactions, or other transaction type as known in the art. Step 212 trickle charges the battery (e.g., up to 6 hours on a timer cycle using a typical household electrical configuration NEMA 5-15) and includes steps 214 and 216.

Step 214 updates visual displays, e.g., LED bars to show current flow with yellow bars indicating present charging and/or battery charging level with green bars indicating charging complete (other indications may be used additionally or alternatively). Step 216 records data about the charging process. Step 218 stops battery charging while step 220 transmits the recorded data, e.g., over a network, via USB, via a remote management module 108 of FIG. 1, or via other wired or wireless communications mechanism. Step 222 receives instructions from a remote management module and may modify any parameter and/or steps of method 200. Step 224 overrides the charging steps and immediately charges the battery.

Additionally, in accordance with FIG. 2, a report generator may be provided. The report generator may create reports such as: utility company reports, detailing power consumed and V2G power sold to local power grid, subscriber reports, detailing power consumed and V2G power sold to the local power grid, account balance, payments and invoices, and subscriber profile data, tax authority reports, details of taxable transactions or any other suitable reports. Also, the report generator may include user profile information. A user profile may include financial account information (e.g., details required for payment) and may also include information such as whether the vehicle operator wants to: charge the vehicle only during periods of lower power rates, not charge the vehicle during periods of high power grid load, and sell power to the local grid.

The vehicle to electricity grid applications and methodology may allow for the user to either pre-register or associate with a local utility company or energy provider which allows for the utility company to control the timing of charging or discharging of the vehicle 104. This allows the utility company during periods of high power consumption to have the option of turning off the charging of the vehicle 104 to help reduce the load on the electric grid controlled by the utility company and to avoid the sometimes necessary rolling blackouts. This also may allow for charging the vehicle 104 during periods of low power consumption by having the utility company to turn the charging of the vehicle 104 back on thus reducing the overall cost of operating the vehicle 104 by allowing for charging of the vehicle 104 during periods of low power consumption which may result in lower kilowatts charges to the user of the vehicle 104.

It is also contemplated to have a methodology that allows the driver or user of the vehicle 104 who periodically travels to a second home or other location to automatically be able to choose the boost charge or extended charge whenever they go to the second home, which is located a predetermined distance from their first home location. It is contemplated that this methodology may also use an onboard location device, such as a global positioning satellite or system (GPS) or the like, in the vehicle 104 to automatically identify that the user has stopped or parked at a second home or location and automatically follow the saved preset charging instructions if not overridden by a new setting or user action. Furthermore, the methodology may be capable of determining that if the cost of electricity may be higher at the second location that the user of the vehicle 104 may wish to charge at a different time of day at that second location to reduce their cost of charging the battery pack of the vehicle 104.

It should be noted that the user through the vehicle communication interface and associated methodologies may be capable of having a preset operating command to automatically reject or accept such charging control or request for such from the utility company. This methodology would allow for the user to override the utility company instruction of stopping charging because of high power consumption if the user of the vehicle 104 needs the battery 102 charged at the current time in order to use the vehicle 104 in the near future. It is contemplated that this type of mutual control between the utility company and the vehicle 104 may be executed via the internet using the 802.11 communication protocol or cell phone communication (or any other suitable communication method) with the vehicle 104 by the user or the utility company. It should also be noted that it is contemplated within this methodology that the utility company may also be capable of remotely querying and sampling the vehicles state of charge for the associated battery pack and then send predetermined and specific instructions or requests to the vehicle 104 and/or user to discharge electricity back into the grid via the vehicle 104 to grid applications stored within the vehicle communication interface.

Although the exemplary embodiments have been described as relating to Ethernet/IP-based data networks, the exemplary embodiments may be similarly applied to any type of data network. Furthermore, although packet networks are the most common for local area networks, the exemplary embodiments are not restricted to packet networks only, and may be applied to any digital/analog data network, where network entities are identified uniquely by addresses. System 100 may be implemented in hardware, software, software in execution, firmware, microcode, CPLDs (complex programming logic device), PALs (programmable array logic), FPLGs (field programmable logic gates), a hardware description language, one or more processors, and the like.

Additionally, the smart grid networks of the exemplary embodiments may comprise one or more WAN networks and/or one or more LAN networks. At least one WAN module may be configured to communicate with a network operations center using standard WAN protocols, and RF spectrum such as the unlicensed spectrum. At least one LAN module may be configured to communicate with local assets and resources using standard protocols such as, PLC (protocol composition logic), Ethernet, or RS-485. Alternatively, the smart grid gateway may be configured to permit service personnel/users/grid operators to run diagnostics, data recovery, and local software updates on the gateway via a LAN connection provided by the LAN module or via a WAN connection provided by the WAN module.

In yet another exemplary embodiment, a hub or external networks or servers may send recommendations/suggestions/advice on saving power through changing usage patterns or suggesting conservation tips after measuring the power usage from each vehicle 104. In another example, the hubs or external networks or servers may provide feedback and other information to the user on environmental factors that result from consumer/user usage patterns and/or decisions. All this data/information may be provided to a user of the vehicle 104 in real-time and on a continuous and uninterrupted basis.

In yet another exemplary embodiment, the smart grid system/network may include electronic storage, which may store historical usage and cost data related to each and every vehicle 104. The electronic storage may be located at the consumer site, the utility company, or a third party location (e.g., a service provider). Furthermore, electronic storage may be located at some or all of these locations or within the vehicle the information applies to. With the historical data or information/historical usage patterns, the various entities associated with the smart grid system/network may perform statistical analysis and look for energy consumption trends concerning the vehicles 104. Analysis may show, for example, that a particular power meter is in need of repair or replacement or that a vehicle 104 is not operating properly.

Additionally, a number of software packages may be developed for the power management gateways to measure/monitor/control a plurality of vehicles 104 and display data/information on one or more visual display means.

An advantage of the present disclosure may be that it provides for the user to pre-register with a local utility company or energy provider to allow for charging of the vehicle at periods of low power consumption, thus reducing the overall cost of operating the vehicle. Another advantage of the present disclosure may include providing the ability to pre-register with the local utility to allow for discharging of the vehicle at periods of high electrical demand, or charging at periods of low demand. It may also provide the necessary information about state of charge, electrical storage device aging, and user driving needs to allow the utility to compensate the user for wear on the electrical storage device, or collect payment from the user for charging the electrical storage device.

The present disclosure further provides a smart-grid communication system including a plurality of vehicles 104, one or more power management gateways in electrical communication with each of the plurality of vehicles 104, and one or more external communication sources. Each of the plurality of vehicles 104 provides power usage information to the one or more power management gateways and to the one or more external communication sources. The present disclosure further provides an electrical power meter in electrical communication with a processor including one or more of a current sensor, a voltage sensor, or a power or wattage sensor.

The present disclosure also includes as an additional embodiment a computer-readable medium which stores programmable instructions configured for being executed by at least one processor for performing the methods described herein according to the present disclosure. The computer-readable medium may include flash memory, CD-ROM, etc.

Although exemplary systems and methods have been described in language specific to structural features and/or methodological acts, it is to be understood that the subject matter defined in the present disclosure is not necessarily limited to the specific features or acts described. Rather, the specific features and acts are disclosed as exemplary forms of implementing the methods, devices, systems, etc. of the present disclosure.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art.

1-47. (canceled)

48. A method for charging a vehicle, the vehicle being at least partially powered by electricity, the method comprising:
receiving electricity via a wall box mounted electrical receptacle or a plug-in receptacle electrically connected to an electrical energy source;
establishing a connection between a communication module of the wall box mounted electrical receptacle or the plug-in receptacle and a communications network;
receiving electrical energy source data; and
remotely controlling the charging of an electrical storage device of the vehicle by controlling the charging, during predetermined periods of time, based on the electrical energy source data communicated by a remote management module and based on user profile information corresponding to a plurality of predetermined options.

49. The method according to claim 48, wherein the electrical energy source data dictates low power consumption time periods for charging the electrical storage device of the vehicle.

50. The method according to claim 48, wherein the charging of the electrical source data of the vehicle is activated by a timing circuit.

51. The method according to claim 48, wherein the controlling step further includes determining a state of charge of the electrical storage device of the vehicle.

52. The method according to claim 48, wherein the controlling step further includes notifying a user that the electrical storage device of the vehicle is fully charged.

53. The method according to claim 48, wherein the controlling step further includes notifying a user that the charging of the electrical storage device of the vehicle is interrupted due to one or more conditions.

54. The method according to claim 53, wherein the one or more conditions include an electrical storage device fault condition or an electrical storage device disconnect condition.

55. The method according to claim 53, wherein the one or more conditions include an overcurrent, overvoltage, leakage current, or a ground fault condition.

56. The method according to claim 48, wherein the controlling step further includes notifying a user that the electrical storage device of the vehicle is being discharged into an electricity grid network in operable communication with the communications network.

57. The method according to claim 48, wherein the controlling step further includes automatically disabling the charging of the electrical storage device of the vehicle during predefined periods.

58. The method according to claim 48, wherein the controlling step further includes providing a user with an electrical storage device charging override capability.

59. The method according to claim 58, wherein the override capability permits the user to override predetermined instructions of stopping of charging due to high power consumption if a user of the vehicle requires the electrical storage device charged at a current time.

60. The method according to claim 48, wherein the electrical energy source is one of a power station, home charging station, service station, municipal station, or an institutional station.

61. The method according to claim 60, further comprising visually identifying at least one electrical parameter from the electrical energy source to the electrical storage device of the vehicle via a metering device, where the at least one electrical parameter is current, voltage, or wattage.

62. The method according to claim 48, further comprising monitoring the charging of the electrical storage device of the vehicle via a wired or wireless network.

63. The method according to claim 62, wherein the step of monitoring comprises monitoring at a remote location.

64. The method according to claim 62, further comprising selectively controlling an amount of power consumption or current flow.

65. The method according to claim 62, further comprising recording an amount of power consumption or current flow by recording time of power or current use and at least one of voltage, current, or wattage use.

66. The method according to claim 62, further comprising providing at least one payment option for allowing a user to pay for the charging of the electrical storage device of the vehicle.

67. The method according to claim 62, further comprising transmitting information related to the charging of the electrical storage device of the vehicle to a data processing apparatus.

68. The method according to claim 67, wherein the data processing apparatus is one of a data center, hard disk drive, and optical drive.

69. The method according to claim 67, wherein the information includes at least one of user profiles, power grid load data, and charge transfer parameters.

70. The method according to claim 48, wherein the electrical energy source data includes one or more of the following: time of day rates, load demand on the communications network, current electricity usage rate of the vehicle, and prior electricity usage rate of the vehicle.

71. A charger for an electrical storage device of a vehicle at least partially powered by electricity, the charger comprising:
a wall box mounted electrical receptacle or a plug-in receptacle configured to receive electricity from an electric power source;
a processing module for controlling the charger by automatically activating charging during at least one predetermined period;
a charge regulator for implementing one or more charging algorithms;
an electricity rate calculation module for monitoring at least one charging parameter; and
a data collection module for storing usage data; and
a communications module configured to communicate over a communications network.

72. The charger of claim 71, wherein the at least one predetermined period is a low power consumption time period.

73. The charger of claim 71, wherein the charger is activated by a timing circuit.

74. The charger of claim 71, wherein the charger is in operable communication with a remote management module, and wherein the remote management module controls at least one of start setting, stop setting, and charging rate on power delivery to the electrical storage device of the vehicle, provides instructions to record at least one of wattage, current, and time.

75. The charger of claim 74, wherein the remote management module receives reports related to service interruptions.

76. The charger of claim 71, wherein the charger further includes a communications component, and wherein the communications component includes at least one of a visual indicator, a network link, a data transfer module, and a transaction module.

77. The charger of claim 71, wherein the electricity rate calculation module receives data related to electricity rates from a communications component or stored data.

78. A method for charging an electrical storage device of a vehicle, the method comprising:
connecting a vehicle to a wall box mounted electrical receptacle or a plug-in receptacle charger;
wherein the wall box mounted electrical receptacle or plug-in receptacle charger performs the steps of:
receiving electricity data from a source or stored data;
calculating a predetermined period in accordance with the electricity data;
transacting a payment mechanism; and
providing electricity to the electrical storage device of the vehicle.
